(19) United States
(12) Patent Application Publication
(10) Pub. No.: US 2012/0024225 A1
(43) Pub. Date: Feb. 2, 2012

(54) GLUE COATING DEVICE

(75) Inventor: XIN-YAN WANG, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/900,704

(22) Filed: Oct. 8, 2010

(30) Foreign Application Priority Data
Jul. 27, 2010 (CN) 201010237977.7

(51) Int. Cl. B05C 3/02

(52) U.S. Cl. 118/429

(57) ABSTRACT

A glue coating device is for coating glue on a work piece. The glue coating device includes a main body defining a number of vents, a mounting space, a dipping space and a channel communicating the mounting space with the dipping space, the dipping space is for dipping the work piece to coat the work piece; a container defining a receptacle in a first end thereof and a glue injecting hole in the second end, the first end of the container releasably mounted in the mounting space. The vents allow air to circulate between the mounting space and the atmosphere.

### BACKGROUND

1. Technical Field

This disclosure relates to glue coating devices, particularly to glue coating devices used for coating fasteners with glue.

2. Description of Related Art

Sometimes, to prevent fasteners such as bolts or fasteners, such as screws, from backing out of holes, glue is applied on the threaded portions of the fastener. One way to apply glue onto fasteners is by dipping the fasteners into a container of glue. However, each time a fastener is coated the level of the glue will be reduced and need to be manually topped up to ensure proper depth for a complete coating of the next fastener.

Therefore, there is a room for improved in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary glue coating device. Moreover, in the drawings like reference numerals designate corresponding parts throughout the several views. Wherever possible, the same reference numbers are used throughout the drawings to refer to the same or like elements of an embodiment.

FIG. 1 is an exploded view of an exemplary embodiment of a glue coating device.

FIG. 2 is another exploded view of the glue coating device shown in FIG. 1.

FIG. 3 is an assembled view of a glue coating device.

FIG. 4 is a cross-sectional view of the glue coating device taken along the line IV-IV of FIG. 3.

FIG. 5 is a schematic view of the glue coating device shown in FIG. 4 in a working state.

### DETAILED DESCRIPTION

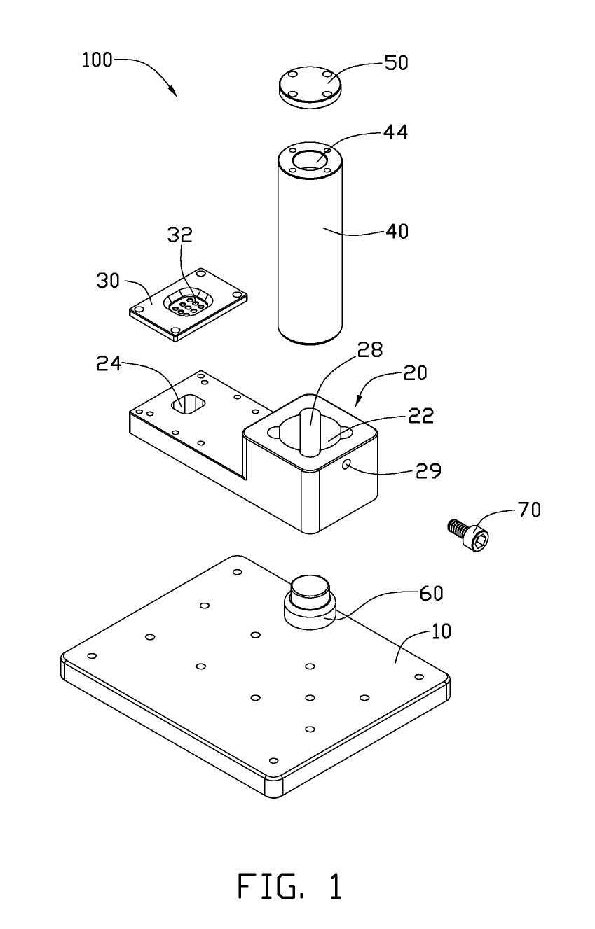

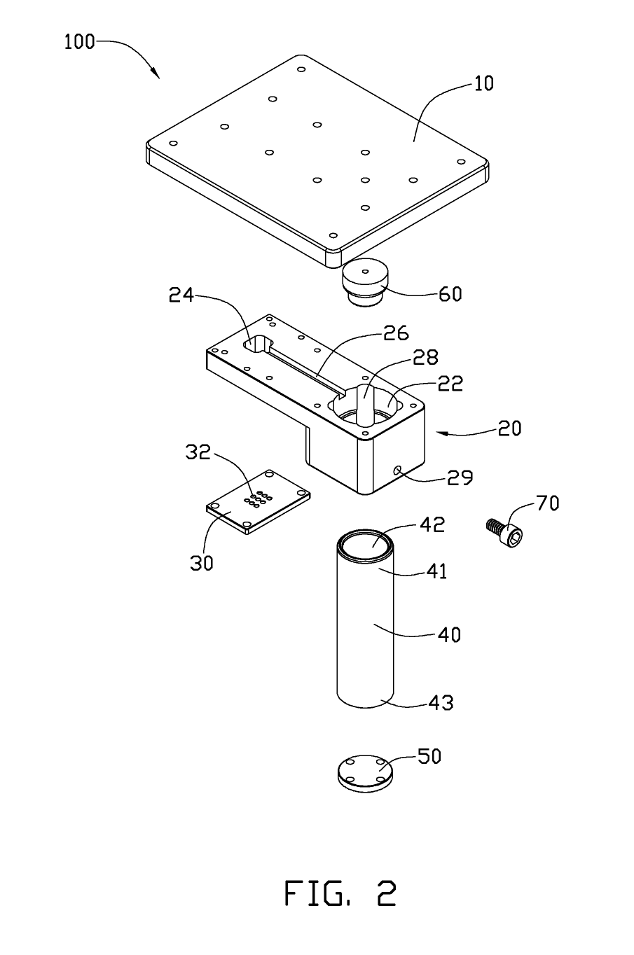

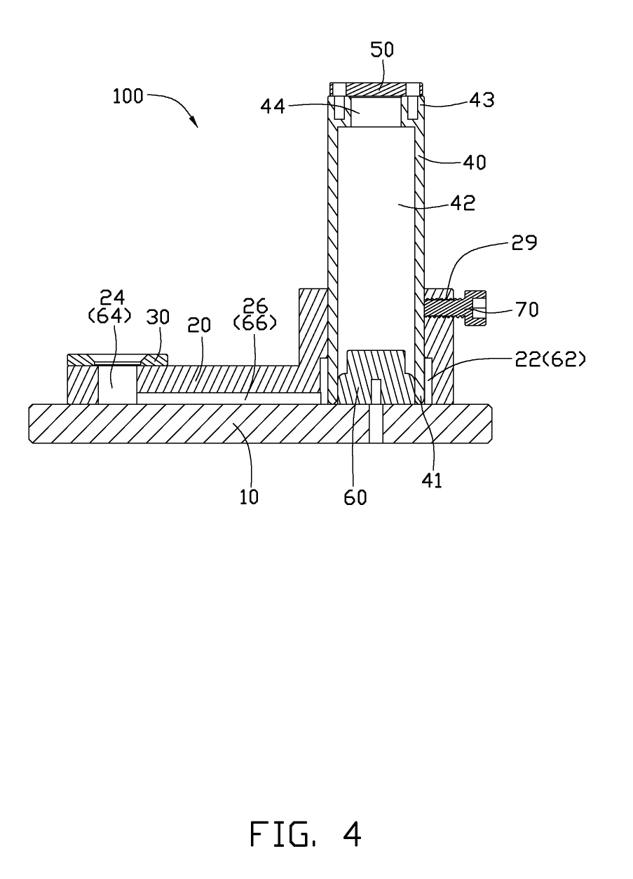

Referring to FIGS. 1-3, an exemplary embodiment of a glue coating device 100 for coating a work piece, such as a fastener (not shown), with glue is shown. The glue coating device 100 includes a base 10, a main body 20 mounted on the base 10, a dipping board 30, a container 40, a cover 50, and a buffer 60. The main body 20 is mounted on the base 10. The main body 20 further defines a first hole 22, a second hole 24, and a slot 26 between the first hole 22 and the second hole 24. The slot 26 is for communicating the first hole 22 with the second hole 24. Referring to FIG. 4, when the base 10 is mounted on the main body 20, a mounting space 62 is formed between the first hole 22 and the base 10, a dipping space 64 is formed between the second hole 24 and the base 10, and a channel 66 is formed between the mounting space 62 and the dipping space 64. The channel 66 is for communicating the mounting space 62 with the dipping space 66. The dipping board 30 covers the main body 20 to shield the dipping space 64. The dipping board 30 defines a plurality of dipping holes 32. The container 40 defines a receptacle 42 in a first end 41 thereof for accommodating glue and a glue injecting hole 44 in a second end 43 thereof for injecting glue into the receptacle 42. The first end 41 of the container 40 is located in the mounting space 62. The cover 50 is for hermetically covering the glue injecting hole 44. Referring to FIG. 4, the buffer 60 is mounted on the base 10 and accommodated in the mounting space 62, and the buffer 60 is accommodated in the receptacle 42 when the container 40 is located in the mounting space 62. The buffer 60 is for reducing the speed of the glue flowing out of the receptacle 42.

The main body 20 further defines a plurality of vents 28 respectively communicating with the mounting space 62. The container 40 is disposed such that when the container 40 is mounted on the main body 20, there is a clearance/space formed between the container 40 and the mounting space 62. The vents 28 allow air to circulate between the mounting space 62 and the atmosphere. The main body 20 further defines a threaded hole 29 communicating with the mounting space 62. The hole 29 is for engaging with a fastener 70.

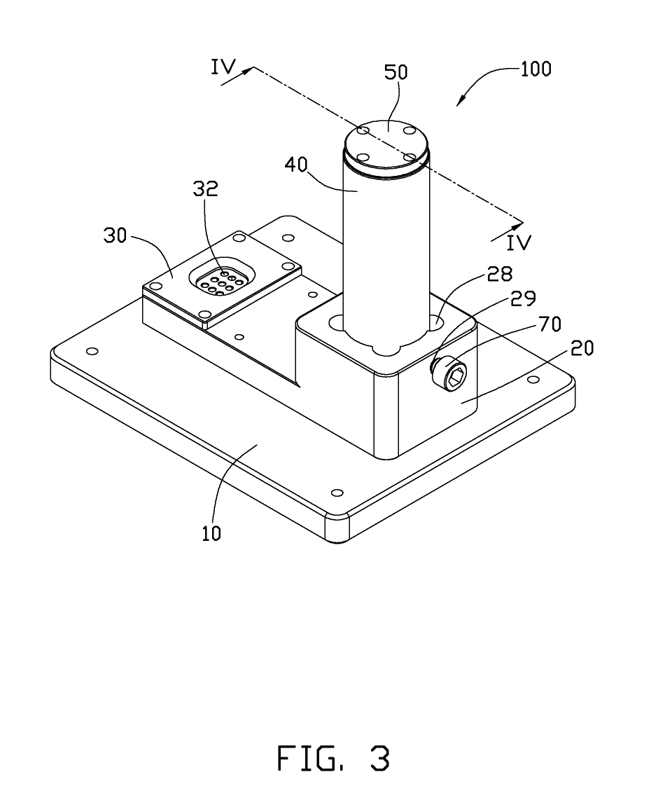

Referring to FIGS. 3 and 4, in assembly, the buffer 60 is mounted on the base 10. The main body 20 is hermetically mounted on the base 10 with the buffer 60 located in the mounting space 62. The dipping board 30 is mounted to the main body 20 to cover the dipping space 64. The first end 41 of the container 40 is inserted in the mounting space 62 until the buffer 60 is accommodated in the receptacle 42. The fastener 70 is fastener in the fastener hole 29 until the fastener 70 resists the container 40 to hold the container 40 in the main body 20.

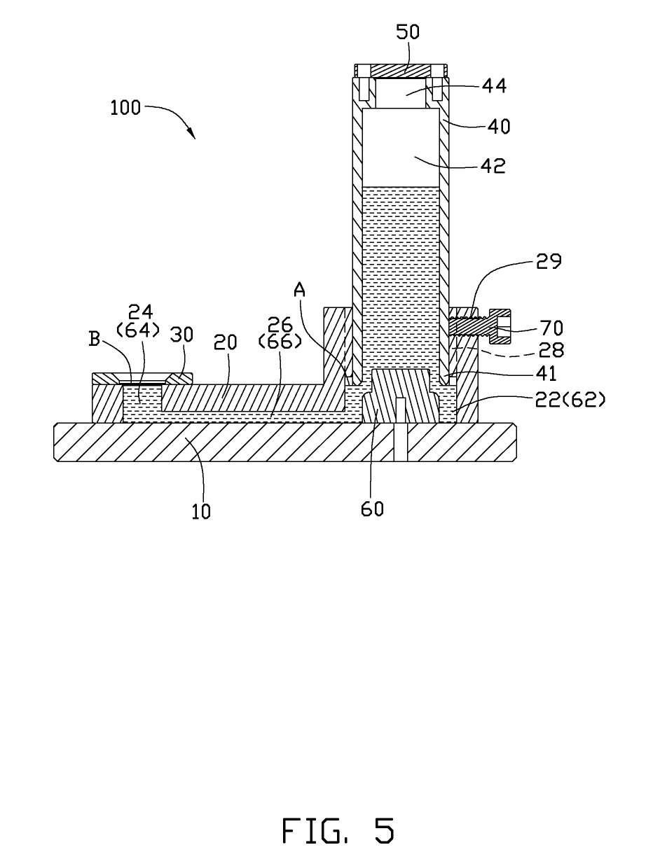

Referring to FIGS. 4 and 5, in use, the cover 50 is removed from the container 40. Glue is then injected into the receptacle 42 from the glue injecting hole 44. The cover 50 covers on the container 40 again. The fastener 70 is adjusted to release the container 40 from the main body 20. The container 40 is then lifted to separate from the base 10, so that the glue in the receptacle 42 will flow into the mounting space 62, the channel 66, and the dipping space 64 under the force of gravity until the glue level in the mounting space 62 is level with the first end 41 of the container 40. The glue will stop flowing out of the receptacle 42 when the glue level in the mounting space 62 is level with the first end 41 because once the glue level in the mounting space 62 is level with the first end 41, the glue in the receptacle 42 is separated from the atmosphere by the glue in the mounting space 62; and the mounting space 62 communicates with the atmosphere by the vents 28, so the glue in the receptacle 42 will stop flowing into the mounting space 62 because of the outside or atmospheric pressure. Additionally, the dipping space 64 is communicated with the mounting space 62 by the channel 66, so the glue level B (FIG. 5) in the dipping space 64 can be level with the glue level A (FIG. 5) in the mounting space 62. To coat fasteners with glue, the fastener is dipped into the glue in the dipping space 64 through one of the dipping holes 32. The glue level B in the dipping space 64 will be reduced after coating the fastener, so the glue in the mounting space 62 will flow in the channel 66 into the dipping space 64. As a result the glue level A in the mounting space 62 will separate from the first end 41 again, so the glue in the receptacle 42 will continue flowing into the mounting space 62, the channel 66, and the dipping space 64 under force of gravity until the glue level A in the mounting space 62 is level with the first end 41. Thus, the glue level B in the dipping space 64 is level with the glue level A in the mounting space 62 again, and all is ready to coat the next fastener.

It is understood that the base 10 and the main body 20 can be integrated into one integrated element in which the mounting space 62, the dipping space 64, and the channel 66 are directly defined in the main body 20.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A glue coating device for coating glue on a work piece, the glue coating device comprising:
a main body defining a plurality of vents, a mounting space, a dipping space and a channel communicating the mounting space with the dipping space, the dipping space being configured for receiving a portion of the work piece to coat the work piece with glue;
a container defining a receptacle in a first end thereof and a glue injecting hole in the second end, the first end of the container releasably mounted in the mounting space;
wherein the vents admit passage of air between the mounting space and the atmosphere.

2. The glue coating device of claim 1, further including a fastener, the main body defining a fastener hole communicating with the mounting space; the fastener fastening in the fastener hole and resisting the container to hold the container in the mounting space.

3. The glue coating device of claim 1, further including a cover covering on the second end to shielding the glue injecting hole.

4. The glue coating device of claim 1, further including a buffer located in the mounting space and the receptacle.

5. The glue coating device of claim 4, wherein the buffer is for reducing the speed of the glue flowing out of the receptacle.

6. The glue coating device of claim 1, further including a dipping board covering on the main body to shielding the dipping space, the dipping board defining a plurality of dipping holes.

7. A glue coating device for coating glue on a work piece, the glue coating device comprising:
a main body defining a mounting space, a dipping space and a channel communicating the mounting space with the dipping space, the dipping space being configured for receiving a portion of the work piece to coat the work piece with glue;
a container defining a receptacle in a first end thereof and a glue injecting hole in the second end, the first end of the container being releasably mounted in the mounting space and forming a clearance between the container and the main body to achieve passage of air between the mounting space and the atmosphere.

8. The glue coating device of claim 7, wherein a plurality of vents defined in peripheral surface of the main body in the mounting space so as to form the clearance between the mounting space and the container.

9. The glue coating device of claim 7, further including a fastener, the main body defining a fastener hole communicating with the mounting space; the fastener fastening in the fastener hole and resisting the container to hold the container in the mounting space.

10. The glue coating device of claim 7, further including a cover covering on the second end to shielding the glue injecting hole.

11. The glue coating device of claim 7, further including a buffer located in the mounting space and the receptacle.

12. The glue coating device of claim 11, wherein the buffer is for reducing the speed of the glue flowing out of the receptacle.

13. The glue coating device of claim 7, further including a dipping board covering on the main body to shielding the dipping space, the dipping board defining a plurality of dipping holes.
